(19) United States
(12) Patent Application Publication
(10) Pub. No.: US 2004/0216235 A1
(43) Pub. Date: Nov. 4, 2004

(54) Bed

(76) Inventor: John Christopher Rees, Mumbeles (GB)

Correspondence Address: David P. Gordon, Gordon & Jacobson, P.C., 65 Woods End Road, Stamford, CT, 06905, US

(21) Appl. No.: 10/852,384

(22) Filed: May 24, 2004

Related U.S. Application Data
(63) Continuation of application No. PCT/GB02/05249, filed on Nov. 22, 2002.

(30) Foreign Application Priority Data
Nov. 22, 2001 (GB) 0128057.7
Nov. 22, 2001 (GB) 0128061.9
Nov. 22, 2001 (GB) 0128063.5
Nov. 22, 2001 (GB) 0128064.3

(51) Int. Cl. A61G 7/015; A61G 7/018

(52) U.S. Cl. 5/618; 5/600

(57) ABSTRACT

An articulated bed comprising at least one actuator (4) for adjusting the configuration of the bed and electronic control means (6) for controlling the operation of the or each actuator (4) according to the output of at least one position measuring device. Thus the configuration of the bed may be accurately set, regardless of the extent to which the bed is loaded.

### BACKGROUND OF THE INVENTION

1. Field of the Invention

The present invention relates to a bed and more particularly to a re-configurable hospital bed.

2. Related Background Art

It is known to prevent the onset of bed-sores by periodically adjusting the surface profile of a hospital bed, by means of one or more electrical, pneumatic or hydraulic actuators, to vary the anatomical points at which a patient is supported.

More elaborate beds comprise electronic control means for adjusting the configuration of the bed in a pre-programmed sequence.

However, the actual configuration of such beds can only be estimated at each stage in the cycle of operation of the bed and will typically deviate from that estimate according to the extent to which the bed is loaded.

It is therefore desirable to provide an alternative control arrangement wherein a bed may be configured more accurately to ensure that a patient is provided with the optimum degree of relief from bed-sores.

We have now devised an arrangement which overcomes the limitations of existing re-configurable, articulated hospital beds.

### SUMMARY OF THE INVENTION

In accordance with the present invention, there is provided an articulated bed comprising at least one actuator for adjusting the configuration of the bed and electronic control means for controlling the operation of the or each actuator according to the output of at least one position measuring device.

Thus the configuration of the bed may be accurately set, regardless of the extent to which the bed is loaded.

The electronic control means may be arranged to continuously or discretely adjust the configuration of the bed according to a pre-determined sequence and/or to allow real-time control of the configuration of the bed by an operator.

Preferably the electronic control means are arranged to operate the or each actuator to prevent any collision between parts of the bed.

Preferably the electronic control means are arranged to log the output of the or each position measuring device, for example to provide evidence for establishing whether a patient has received the required degree of care.

Preferably said at least one position measuring device comprises a respective position measuring device associated with, and preferably incorporated into, the or each actuator.

Preferably the or each actuator is driven from a re-chargeable electrical supply, the electronic control means being arranged to charge the re-chargeable supply, from a mains supply, when no actuator is being driven.

Preferably the electronic control means are arranged to sense to extent to which the re-chargeable supply is charged and to prevent operation of the or each actuator where the re-chargeable supply stores less than a pre-determined amount of charge.

Preferably the electronic control means are arranged to sense the amount of current drawn by the or each actuator, for example to detect an abnormal load or fault condition.

Preferably the electronic control means are arranged to be connected to external data processing means, for example to remote monitoring, data logging or diagnostics means (for identifying mechanical/electrical faults).

Preferably the electronic control means comprise a microcontroller.

Preferably the electronic control means are arranged to communicate with at least one peripheral device, such as an electronic sensing device. Preferably the electronic control means are arranged to communicate with the or each peripheral device via a data communications bus.

Preferably the data communications bus comprises at least one nodes to which a peripheral device may be selectively connected. The or each node may be arranged for the connection thereto of a single respective type of device, or may be arranged to operate in different modes according to the type of peripheral device connected thereto.

Preferably the peripheral device comprises an electronic sensing device and the electronic control means are arranged to log output signals from the sensing device.

Preferably the electronic sensing device comprises a device selected from at least the following: an anti-entrapment device; a device which senses whether the bed is occupied (which may comprise a weight sensing device); a moisture sensing device for detecting whether a patient has urinated in the bed; a vibration sensing device; and a device recording the attendance of a care worker (such as a swipe card reader).

Alternatively the peripheral device may comprise a hand-held controller via which an operator may program the electronic control means to determine the sequence according to which the configuration of the bed will subsequently be adjusted or via which an operator may control the configuration of the bed in real time. In the former case, the hand-held controller preferably comprises display means.

Also in accordance with the present invention, there is provided a bed comprising at least one electronic sensing device and electronic data logging means arranged to log the output of the or each sensing device.

Preferably the data logging means are arranged to receive signals from the or each sensing device via a data communications bus to which the or each sensing device may be selectively connected.

Preferably the or each sensing device comprises a device selected from at least: an anti-entrapment device; a device which senses whether the bed is occupied (which may comprise a weight sensing device); a moisture sensing device for detecting whether a patient has urinated in the bed; a vibration sensing device; a device recording the attendance of a care worker (such as a swipe card reader).

Further in accordance with the present invention, there is provided an articulated bed comprising at least one actuator for adjusting the configuration of the bed and electronic control means for controlling the operation of the or each actuator in response to control signals from a remote hand-held controller and in one of two modes, according to whether the hand-held controller is of a first type or a second type.

Thus, for example, a care worker may be provided with a first type of controller and a patient with a second type of controller, to allow the care worker to control functions of the bed not controllable by the patient.

The hand-held controller may, for example, provide a means via which an operator may program the electronic control means to determine a sequence according to which the configuration of the bed will subsequently be adjusted or via which an operator may control the configuration of the bed in real time. In the former case, the hand-held controller preferably comprises display means.

Still further in accordance with the present invention, there is provided an articulated bed comprising at least one actuator for adjusting the configuration of the bed and electronic control means for controlling the operation of the or each actuator, the electronic control means being arranged to be remotely interrogated, via a telecommunications link, to identify any mechanical or electrical fault condition of the bed.

The present invention also encompasses electronic control means arranged to control the operation of at least one actuator to adjust the configuration of an articulated bed according to the output of at least one position measuring device and/or in response to control signals from a hand-held controller and in one of two modes, according to whether the hand-held controller is of a first or a second type and/or with the electronic control means arranged to be remotely interrogated, via a telecommunications link, to identify any mechanical or electrical fault condition of the bed.

### BRIEF DESCRIPTION OF THE DRAWINGS

An embodiment of the present invention will now be described by way of examples only and with reference to the accompanying drawings, in which:

FIG. 1 is a schematic side elevation of a bed in accordance with the present invention; and

FIG. 2 is a schematic block diagram of an electronic control system of the bed.

### DETAILED DESCRIPTION OF THE PREFERRED EMBODIMENT

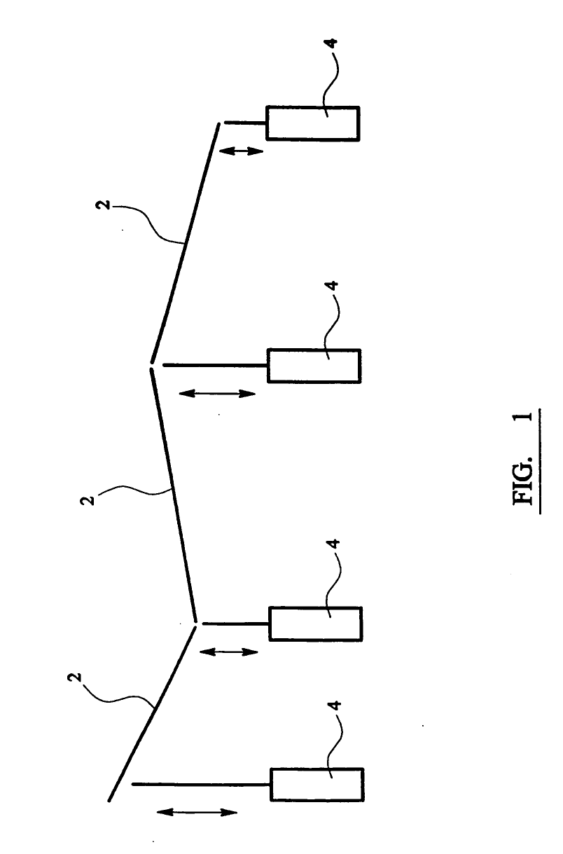

Referring to FIG. 1 of the drawings, an articulated hospital bed is shown comprising a plurality of surface sections 2 for supporting a patient, the height and inclination of each of the sections being adjustable by means of a plurality of linear actuators 4, to vary the surface profile of the bed.

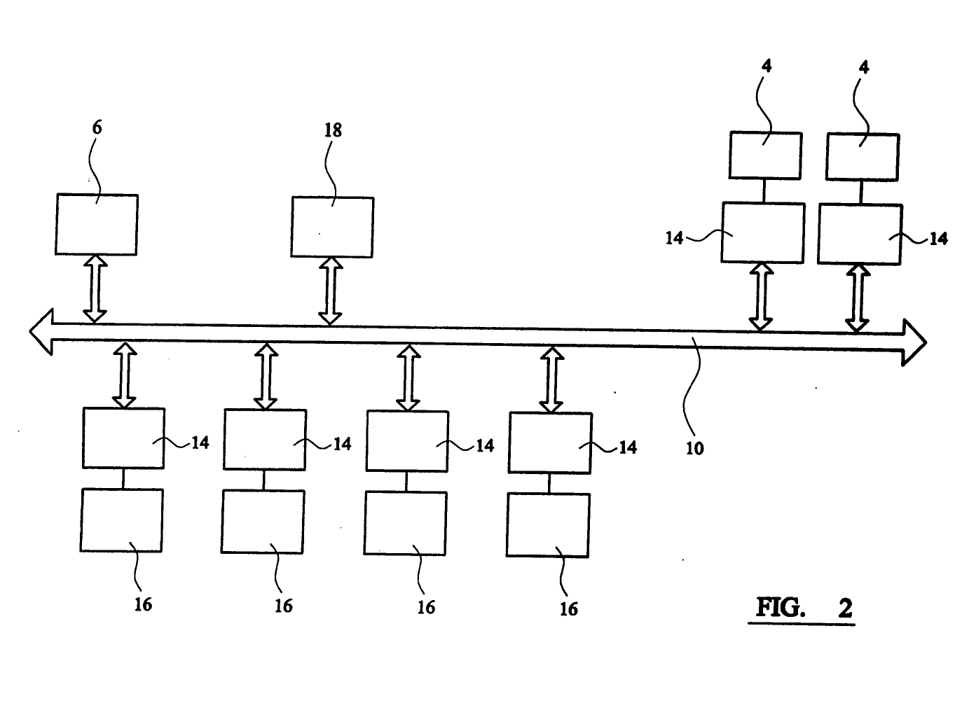

The linear actuators 4 are each controlled by an electronic bed control system, shown as a schematic block diagram in FIG. 2, the control system comprising a microcontroller-based controller 6 arranged to control the supply of power from a rechargeable power supply 8 to each of the actuators 4, to thereby adjust the configuration of the bed, either according to a programmed sequence or in real time under the control of an operator.

The prevailing configuration of the bed is determined by the controller 6 from the outputs of a plurality of position measuring devices, in the form respective Hall-effect sensors incorporated into each of the actuators 4, which communicate with the controller 6 via a multiplexed data bus 10. Such an arrangement ensures that a desired surface profile for the bed may be accurately set, regardless of the degree of loading to which the bed is subjected.

Calculations made by the controller 6 ensure that no collisions occur between parts of the bed during any adjustment of its configuration.

The controller 6 also maintains a timed log of the outputs of the various position measuring devices, in case this data should subsequently be required, for example as evidence of correct use of the bed.

When no actuator 4 is being driven, the controller 6 causes the rechargeable supply 8 to be charged from a mains supply. Thus, a sufficient amount of residual charge should always be held by the rechargeable supply 8. However, as a safety precaution, the controller is arranged to sense to extent to which the re-chargeable supply 8 is charged and to prevent operation of the actuators 4 where less than a pre-determined amount of charge is stored.

By sensing the amount of current drawn by the or each actuator 4, the controller 6 is also able to detect any abnormal load or fault conditions that may arise.

The controller 6 is arranged to communicate with the position measuring devices and with a one or more peripheral input or output devices 16 via the data communications bus 10.

The data communications bus 10 comprises a plurality of nodes 14, to each of which a respective peripheral device 16 such as an operating hand-set, an anti-entrapment device, a device which senses whether the bed is occupied, a moisture sensing device for detecting whether a patient has urinated in the bed, a vibration sensing device, or a device recording the attendance of a care worker (such as a swipe card reader) may be selectively connected, the controller 6 being arranged to log the output signals of any such device 16 connected to the bus 10.

An interface 18 is also provided for connecting the controller 6 to external data processing means, for example to remote monitoring, data logging or diagnostics means (for identifying mechanical/electrical faults in the bed or controller).

The apparatus thus described provides for an improved level of patient care in a hospital or other such facility.

While the preferred embodiment of the invention has been shown and described, it will be understood by those skilled in the art that changes of modifications may be made thereto without departing from the true spirit and scope of the invention.

I claim:

1) An articulated bed comprising at least one actuator for adjusting the configuration of the bed and electronic control means for controlling the operation of the or each actuator according to the output of at least one position measuring device.

2) An articulated hospital bed as claimed in claim 1, wherein the electronic control means are arranged to continuously or discretely adjust the configuration of the bed according to a pre-determined sequence.

3) An articulated bed as claimed in claim 1, wherein the electronic control means are arranged to allow real-time control of the configuration of the bed by an operator.

4) An articulated bed as claimed in Claim 1, wherein the electronic control means are arranged to operate the or each actuator to prevent any collision between parts of the bed.

5) An articulated bed as claimed in claim 1, wherein the electronic control means are arranged to log the output of the or each position measuring device.

6) An articulated bed as claimed in claim 1, wherein said at least one position measuring device comprises a respective position measuring device associated with the or each actuator.

7) An articulated bed as claimed in claim 6, wherein said at least one position measuring device comprises a respective position measuring device incorporated into each actuator.

8) An articulated bed as claimed in claim 1, wherein the or each actuator is driven from a re-chargeable electrical supply, the electronic control means being arranged to charge the re-chargeable supply, from a mains supply, when no actuator is being driven.

9) An articulated bed as claimed in claim 1, wherein the electronic control means are arranged to sense to extent to which the re-chargeable supply is charged and to prevent operation of the or each actuator where the re-chargeable supply stores less than a pre-determined amount of charge.

10) An articulated bed as claimed in claim 1, wherein the electronic control means are arranged to sense the amount of current drawn by the or each actuator.

11) An articulated bed as claimed in claim 1, wherein the electronic control means are arranged to be connected to external data processing means.

12) An articulated bed as claimed in claim 1, wherein the electronic control means comprise a microcontroller.

13) An articulated bed as claimed in claim 1, wherein the electronic control means are arranged to communicate with at least one peripheral device.

14) An articulated bed as claimed in claim 13, wherein the electronic control means are arranged to communicate with the or each peripheral device via a data communications bus.

15) An articulated bed as claimed in claim 14, wherein the data communications bus comprises at least one node to which a peripheral device may be selectively connected.

16) An articulated bed as claimed in claim 15, wherein the or each node is arranged for the connection thereto of a single respective type of device.

17) An articulated bed as claimed in claim 15, wherein the or each node is arranged to operate in different modes according to the type of peripheral device connected thereto.

18) An articulated bed as claimed in claim 13, wherein said at least one peripheral device comprises an electronic sensing device and the electronic control means are arranged to log output signals from the sensing device.

19) An articulated bed as claimed in claim 13, wherein the peripheral device comprises a device selected from: an anti-entrapment device; a device which senses whether the bed is occupied (which may comprise a weight sensing device); a moisture sensing device for detecting whether a patient has urinated in the bed; a vibration sensing device; and a device recording the attendance of a care worker (such as a swipe card reader).

20) A bed comprising at least one electronic sensing device and electronic data logging means arranged to log the output of the or each sensing device.

21) A bed as claimed in claim 20, wherein the data logging means are arranged to receive signals from the or each sensing device via a data communications bus to which the or each sensing device may be selectively connected.

22) A bed as claimed in claim 21, wherein the or each sensing device comprises a device selected from: an anti-entrapment device; a device which senses whether the bed is occupied (which may comprise a weight sensing device); a moisture sensing device for detecting whether a patient has urinated in the bed; a vibration sensing device; a device recording the attendance of a care worker (such as a swipe card reader).

23) An articulated bed comprising at least one actuator for adjusting the configuration of the bed and electronic control means for controlling the operation of the or each actuator in response to control signals from a remote hand-held controller and in one of two modes, according to whether the hand-held controller is of a first type or a second type.

24) An articulated bed comprising at least one actuator for adjusting the configuration of the bed and electronic control means for controlling the operation of the or each actuator, the electronic control means being arranged to be remotely interrogated, via a telecommunications link, to identify any mechanical or electrical fault condition of the bed.

25) Electronic control means arranged to control the operation of at least one actuator to adjust the configuration of an articulated bed according to the output of at least one position measuring device.

26) Electronic control means arranged to control the operation of at least one actuator to adjust the configuration of an articulated bed in response to control signals from a hand-held controller and in one of two modes, according to whether the hand-held controller is of a first or a second type.

27) Electronic control means arranged to control the operation of at least one actuator to adjust the configuration of an articulated bed, the electronic control means being arranged to be remotely interrogated, via a telecommunications link, to identify any mechanical or electrical fault condition of the bed.
